(19) United States
(12) Patent Application Publication
(10) Pub. No.: US 2010/0201712 A1
(43) Pub. Date: Aug. 12, 2010

(54) MOBILE ELECTRONIC DEVICE WITH COMPETING INPUT DEVICES

(75) Inventors: Raphael Grignani, Woodland Hills, CA (US); Mike Kruzeniski, Santa Monica, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/440,115

(22) PCT Filed: Sep. 5, 2006
(86) PCT No.: PCT/EP06/08621

§ 371 Date: Apr. 8, 2010

(51) Int. Cl. G09G 5/00; G09G 5/08; G06F 3/02

(52) U.S. Cl. 345/660; 345/158; 345/169

(57) ABSTRACT

A mobile electronic device that can be used in at least two different orientations. The mobile electronic device comprises a processor, an orientation sensor, and at least two competing input devices. The processor is configured to enable and disable the competing input devices in accordance with the orientation of the mobile electronic device as detected by the orientation sensor. Alternatively, the processor is configured to assign different control functions to the competing input devices and possibly to interchange these control functions in response to a signal from the orientation sensor. The device may have a scrollbar that is an integral part of a keypad. The device may have a scrollbar that is wrapped around a corner of the device. The device may have two scrollbars that are arranged transversely to one another with the longitudinal extremity of the touch surface one of the scrollbars connecting to the touch surface of the other scrollbar.

### RELATED APPLICATION

This application was originally filed as PCT Application No. PCT/ep2006/008621 filed Sep. 5, 2006.

### FIELD OF THE INVENTION

The present invention relates to mobile electronic devices that include input devices and that can be used in two or more different orientations.

### BACKGROUND OF THE INVENTION

Mobile electronic devices include a user interface with input devices that typically are only suitable for use in one particular orientation of the mobile electronic device. However, the functions that are included in mobile electronic devices are ever-increasing and often include camera functions, music player functions, radio functions, telephone functions, loudspeaker functions, messaging functions, office applications and many others, each having different user interface needs. In the so-called smart phones that typically include a myriad of the above listed functions the user interface usually includes a keypad with alphanumerical keys, call handling keys, soft keys and a number of single function keys, such as a menu access key and clear key. The ever increasing complexity of these devices requires an adapted user interface. Thus, there is a need for a user interface that is better adapted to handle the increased complexity of mobile electronic devices.

### DISCLOSURE OF THE INVENTION

On this background, it is an object of the present invention to provide a mobile electronic device with a user interface that is better adapted to handle complex functionality of the terminal. This object is achieved by providing a mobile electronic device that can be used in at least two different orientations, the mobile electronic device comprising a processor controlling the operation of the mobile electronic device, an orientation sensor for detecting the current orientation of the mobile electronic device, a first input device for accepting user input when the mobile electronic device is in a first orientation, and a second input device for accepting user input when the mobile electronic device is in a second orientation, the orientation sensor, the first input device and the second input device being coupled to the processor and the processor being configured enable and disable the first input means and the second input means in accordance with the orientation of the terminal as detected by the orientation sensor.

It has now been realized that some of the many functions of a mobile electronic device, such as a camera function require the terminal to be held in a different orientation, and it has been realized that there is an advantage in selectively differing the orientation of the mobile electronic device for various applications/functions of the terminal. By providing two competing input devices that are selectively enabled/disabled it becomes possible to provide a user interface that is constructed for use with a mobile electronic device that is to be used in at least two different orientations.

Preferably, the processor is configured to disable the second input device when the orientation sensor detects that the terminal is in the first orientation range. Simultaneously, the first input device may be enabled. The processor may also be configured to disable the first input device when the orientation sensor detects that the terminal is in the second orientation range. Simultaneously, the second input device may be enabled.

Thus, there is a clear enablement separation between the two competing input devices that can be readily recognized by a user of the terminal.

Preferably, the first input device and the second input device are substantially identical devices.

The first input device may have an orientation adapted for use in the first orientation and the second input device may have an orientation adapted for use in the first orientation.

The first input device and/or the second input device can be a keypad, a touchpad, a scroll key, a touch sensitive scroll surface, a rotator, a scroll wheel, a joystick or a slide switch.

It is another object of the present invention to provide a method of controlling the enablement status of two or more competing input devices of a mobile electronic device provided with an orientation sensor for detecting the current orientation of the mobile electronic device, comprising disabling and enabling the first input device and the second input device in accordance with the orientation of the mobile electronic device as detected by the orientation sensor.

The method may further comprise the step of enabling the first input device and disabling the second input device when the orientation sensor detects that the mobile electronic device is in a first orientation range.

The method may also comprise the step of enabling the second input device and disabling the first input device when the orientation sensor detects that the mobile electronic device is in a second orientation range.

It is further object of the present invention to provide a software program product executing the above methods when run on a processor.

It is yet another object on the present invention to provide a software product for use in a mobile electronic device that is provided with an orientation sensor and two competing input devices, the software product comprising software code for selectively enabling and disabling the first input device, software code for selectively enabling and disabling the second input device, and software code for determining enablement status of the first input device and the second input device on the basis of the current orientation of the terminal as detected by the orientation sensor.

Preferably, the software product further comprises software code for enabling the first input device and disabling the second input device when the orientation sensor detects that the mobile electronic device is in a first orientation range.

The software product may also comprise software code for enabling the second input device and disabling the first input device when the orientation sensor detects that the mobile electronic device is in a second orientation range.

It is another object of the present invention to provide a mobile electronic device with a user interface that is better adapted to handle complex functionality of the terminal. This object is achieved by providing a mobile electronic device that can be used in at least two different orientations, the mobile electronic device comprising an elongated housing a processor controlling the operation of the mobile electronic device, a first scrollbar supported by the elongated housing with the scrollbar extending in a direction substantially traverse to the longitudinal axis of the elongated housing, a second scrollbar supported by the elongated housing with the scrollbar substantially extending in the direction of the longitudinal axis of the elongated housing, the first scrollbar and the second scrollbar being coupled to the processor and the processor being configured to associate a first control function of an application associated with the mobile electronic device to the first scrollbar and to associate a second control function of the application associated with the mobile electronic device to the second scrollbar.

The two simultaneously available control functions enhance the power that users have over an application on the terminal. Thus, the device becomes more suitable to handle complex applications.

The electronic device may further comprise a display screen coupled to the processor, wherein the application is application displaying an array of items and the first control function is a scroll function and the second control function is a zooming or detail level control function. The items can be menu items and the zooming or detail level control function controls the displayed level of detail associated with the menu items.

Alternatively, the media items are images or videos displayed by a media player and the zooming or detail level control function controls the size of the displayed images or videos on the display screen. The media items can also be songs displayed by a media player, and the zooming or detail level control function controls the displayed level of detail associated with the songs. The items can be phone book entries displayed by a phonebook application, and the zooming or detail level control function controls the displayed level of detail associated with the phonebook entries.

The electronics may further comprise an orientation sensor, in which case the processor is configured to interchange the control functions associated with the first and second scrollbars in response to a signal from the orientation sensor.

It is another object of the invention to provide a method for user input to an electronic device that can be used in at least two different orientations, the mobile electronic device comprising an elongated housing, a first scrollbar supported by the elongated housing with the scrollbar extending in a direction substantially traverse to the longitudinal axis of the elongated housing, and a second scrollbar supported by the elongated housing with the scrollbar substantially extending in the direction of the longitudinal axis of the elongated housing, the method comprising associating a first control function of an application associated with the mobile electronic device to the first scrollbar, and associating a second control function of the application associated with the mobile electronic device to the second scrollbar.

The method may further comprise interchanging the control functions associated with the first and second scrollbars in response to a signal from an orientation sensor.

It is a further object of the present invention to provide a software product for use in a mobile electronic device that is provided with an elongated housing, a first scrollbar supported by the elongated housing with the scrollbar extending in a direction substantially traverse to the longitudinal axis of the elongated housing, and a second scrollbar supported by the elongated housing with the scrollbar substantially extending in the direction of the longitudinal axis of the elongated housing, the software product comprising

software code for associating a first control function of an application associated with the mobile electronic device to the first scrollbar, and software code for associating a second control function of the application associated with the mobile electronic device to the second scrollbar.

It is another object of the present invention to provide a mobile electronic device comprising a housing, a scrollbar supported by the housing, and a keypad supported by the housing, wherein the scrollbar and the keypad overlap one another, with one or more of the keys on a keypad being mapped under the scrollbar.

Thus, the addition of one or more scrollbars does not consume any additional operating face area. Since the mobile device may through the use of scrollbars do without a navigation key, precious operating face area can be liberated for other purposes.

The scrollbar can be an integral part of the keypad.

The electronic device may further comprise a processor coupled to the keypad and to the scrollbar, in which case the processor is configured to treat a substantially non-sliding touch on the scrollbar as a keystroke.

Alternatively, the processor can be configured to treat a substantially non-sliding touch on the scrollbar in one of the areas of the scrollbar that are mapped as a key of the keypad as a keystroke. Alternatively the processor is configured treat a non-sliding touch on the scrollbar in one of the areas of the scrollbar that are mapped as a key of the keypad as a keystroke when the touch is brief or momentary.

Typically, at least a substantial portion of the keys of the keypad are mapped as columns and rows. The first scrollbar may form at least a part of one of the rows and the second scrollbar may form at least part of one of the columns.

It is another object of the invention to provide an electronic device comprising a housing having at least one front surface and one side and/or rear surface, an elongated scrollbar supported by the housing, wherein a portion of the length of the scrollbar is supported by the front surface and a portion of the scrollbar is supported by the side surface and/or the rear surface.

Thus, the operating face of the device is extended, thereby allowing for an enlarged operating area and an increased effective length of the scrollbar, which in turn provides a user with an increased level of control over the device.

Preferably, the scrollbar is wrapped around an edge of the housing. The scrollbar may be wrapped completely around the housing. The scrollbar may also form a continuous strip of touch surface surrounding the housing, which allows a continuous “swirling” input from a user without ever reaching a physical extremity of the scrollbar.

It is another object of the present invention to provide an electronic device comprising a housing, a first elongated scrollbar supported by a face of the housing, a second elongated scrollbar supported by the housing, wherein the second scrollbar is arranged substantially transverse to the first elongate scrollbar with one of the longitudinal extremities of the touch surface of the second scrollbar connecting to the touch surface of the first scrollbar.

Thus, a user can in “one hand” operation move from the touch surface of the one scrollbar to the touch surface of the other scrollbar without needing to lift his/her finger.

Preferably, the connection between the two touch surfaces is substantially in the middle of the longitudinal extension of the first horizontal scrollbar.

Alternatively, the connection between the two touch surfaces is at or near one of the longitudinal extremities of the first horizontal scrollbar.

The connection between the two touch surfaces may be substantially flush.

The touch surfaces of the two scrollbars can be manufactured from one piece of material.

Further objects, features, advantages and properties of the mobile electronic device, method and software product according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 is a front view of a mobile electronic device according to a first embodiment of the invention in an upright position,

FIG. 1A is a front view of a mobile electronic device of FIG. 1 in a horizontal position,

FIG. 2 is a side view of the mobile electronic device of FIG. 1,

FIG. 3 is a block diagram illustrating the general architecture of the mobile phone of FIG. 1,

FIG. 4 is a front view of a mobile electronic device according to a second embodiment of the invention,

FIG. 5 is a rearview of the mobile electronic device of FIG. 4,

FIG. 6 is a front view of a mobile electronic device according to a third embodiment of the invention, and

FIG. 7 is an elevated view of a variation of mobile electronic device according to the embodiment of FIG. 6.

### DETAILED DESCRIPTION OF PREFERRED EMBODIMENTS

In the following detailed description, the method, the software product and the mobile electronic device according to the invention in the form of a cellular/mobile phone will be described by the preferred embodiments.

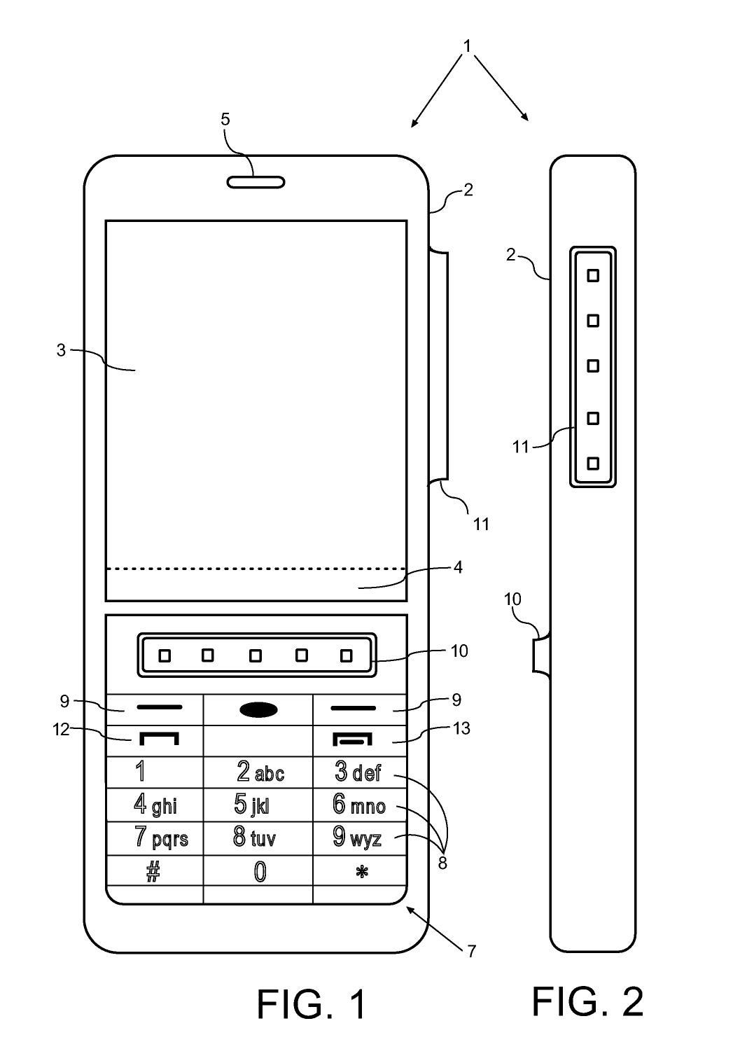

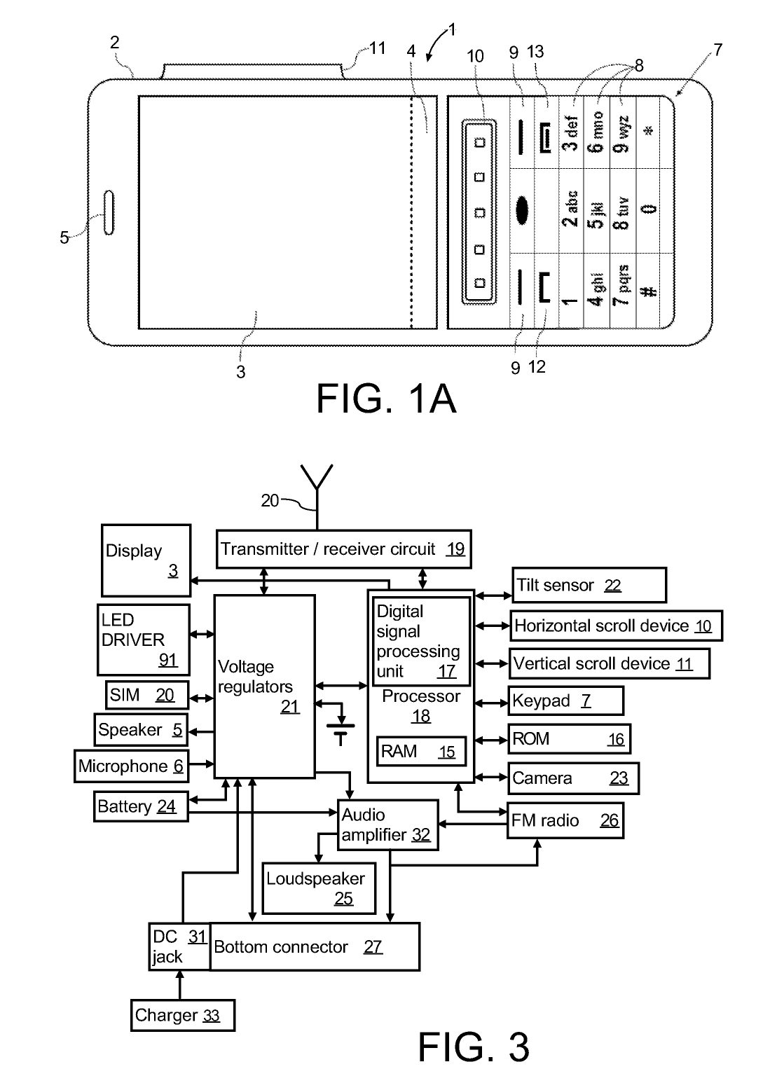

FIGS. 1, 1A and 2 illustrate a first embodiment of a mobile electronic device according to the invention in the form of a mobile telephone 1 by a front view and a side view, respectively. In FIGS. 1 and 2 the mobile phone is depicted in an upright position/orientation, whilst in FIG. 1A the phone is shown in a horizontal position/orientation. The mobile phone 1 comprises a user interface having an elongated housing 2, a display screen 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key 12 and onhook key 13), a scroll surface 10 for scrolling left and right, a scroll surface 11 for scrolling up and down as well as a select/activate key 14. The scroll surfaces can be formed by an array of capacitive touch sensors. The function of the softkeys 9 depends on the state of the phone, and navigation in the menu is performed by using the scroll surface 10,11. The present function of the softkeys 9 is shown in separate fields (soft labels) in a dedicated area 4 of the display screen 3, just above the softkeys 9. The two call handling keys 12,13 are used for establishing a call or a conference call, terminating a call or rejecting an incoming call. This key layout is characteristic for e.g. the Nokia 6230i™ phone.

A releasable rear cover (not shown) gives access to the SIM card 20 (FIG. 3), and the battery pack 24 (FIG. 3) in the back of the phone that supplies electrical power for the electronic components of the mobile phone 1.

The mobile phone 1 has a flat display screen 3 that is typically made of an LCD with optional back lighting, such as a TFT matrix capable of displaying color images. A touch screen may be used instead of a conventional LCD display.

FIG. 2 illustrates in block diagram form the general architecture of a mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 91 (for the LEDS backlighting the keypad 7 and the display screen 3), the SIM card 20, battery 24, the bottom connector 27, the DC jack 31 (for connecting to the charger 33) and the audio amplifier 33 that drives the (hands-free) loudspeaker 25.

The processor 18 also forms the interface for some of the peripheral units of the device, including and a Flash ROM memory 16, the graphical display screen 3, the keypad 7, the horizontal scroll device 10, the vertical scroll device 11, a tilt/orientation sensor 22, a camera 23 and an FM radio 26.

The orientation sensor 22 detects the actual orientation of the mobile phone 1. The processor 18 determines in accordance with the orientation information received from the orientation sensor 21 if any changes to the operational state of the phone need to be made. Hereto, the operating program in memory 16 includes routines for instructing the processor 18 how to react to changes in the orientation of the mobile phone 1. One of the aspects that the processor 18 is programmed to adapt in reaction to changes in the orientation of the mobile phone 1 is the enablement and disablement of the horizontal scroll device 10 and the vertical scroll device 11. In certain states of the mobile phone 1, such as for example states of the mobile phone in which a scrollable list of menu items is shown on the display screen 3 the processor 18 is programmed to selectively enable and disable the horizontal scroll device 10 and the vertical scroll device 11.

In another embodiment, the processor 18 is programmed to assign to the horizontal scroll device 10 a first control function of an application associated with the mobile electronic device 1 and to assign to the vertical scroll device 11 a second control function of the application associated with the mobile electronic device 1. The first control function and the second control function are different from one anther.

When the orientation sensor 22 detects that the mobile phone 1 is in the upright orientation shown in FIG. 1 the processor 18 is instructed to display a scrollable list with (media) items on the display screen 3 so that it is suitable for reading with the mobile phone in the upright position. Further, the routines in the memory 16 instruct the processor 18 to enable the vertical scroll device 11 and to disable the horizontal scroll device 10 or to assign another function to the horizontal scroll device 10, such as controlling the level of displayed detail or zoom of the (media) items. Thus, when holding the mobile phone 1 upright in one hand a user can scroll through the list by sliding his/her to thumb over the vertical scroll device 11, and according to an embodiment control the level of displayed detail of the media items by sliding one of his/her fingers over the horizontal scroll device 10.

The items can be menu items and the zooming or detail level control function controls the displayed level of detail associated with the menu items. The media items can be images displayed by an image viewing application and the zooming or detail level control function controls the size of the displayed images on the display screen 3. The media items can be songs or videos displayed by a media player, in which case the zooming or detail level control function controls the displayed level of detail associated with the songs or videos. The items can phone book entries displayed by a phonebook application, in this case the zooming or detail level control function controls the displayed level of detail associated with the phonebook entries. The items can be calendar entries displayed by a calendar application, in this case the zooming or detail level control function controls the displayed level of detail associated with the calendar entries. For other types of (media) items displayed in scrollable list or array similar detail/zoom control functions can be used.

When the orientation sensor 22 detects that the mobile phone is in a horizontal orientation as shown in FIG. 1A, the processor 18 is instructed to display the scrollable list on the display screen 3 so that it is suitable for reading with the mobile phone in the horizontal position (i.e. the orientation of the information of the display screen 3 is automatically adapted to the new orientation of the mobile electronic device 1). Simultaneously, the program code in the flash ROM 16 instructs the processor 18 to enable the horizontal scroll device 10 (which has now assumed a vertical position) and to disable the vertical scroll device 11, or according to an embodiment, to interchange the control functions assigned to the horizontal and vertical scroll devices 10,11. Thus, when holding the mobile phone 1 in a horizontal position in one hand, a user can scroll through the list by sliding his/her thumb over the horizontal scroll device 10, and according to an embodiment the user can control the level of displayed detail of the media items by sliding one of his/her fingers over the vertical scroll device 11.

In respect to the embodiment above the terms “upright orientation” and “horizontal orientation” are not to be construed as limited to orientations that exactly align with the upright direction and horizontal direction of the gravitational field, but rather as ranges of orientations around a perfectly upright position and a perfectly horizontal position.

According to a variation on the first embodiment the software in the mobile phone 1 instructs the processor 18 to assume a “phone mode” when the orientation sensor 22 detects that the mobile phone 1 is in a substantial upright position whilst at the same time disabling the horizontal scroll device 10 and enabling the vertical scroll device 11. The software in the mobile phone instructs the processor 18 to assume a “camera mode” when the orientation sensor 22 detects that the mobile phone 1 has assumed a substantially horizontal position. Simultaneously, the processor 18 enables the horizontal scroll device 10 and disables the vertical scroll device 11. Thus, the vertical scroll device 11 can be used for “phone scrolling” and the horizontal scroll device 10 can be used for “camera scrolling”.

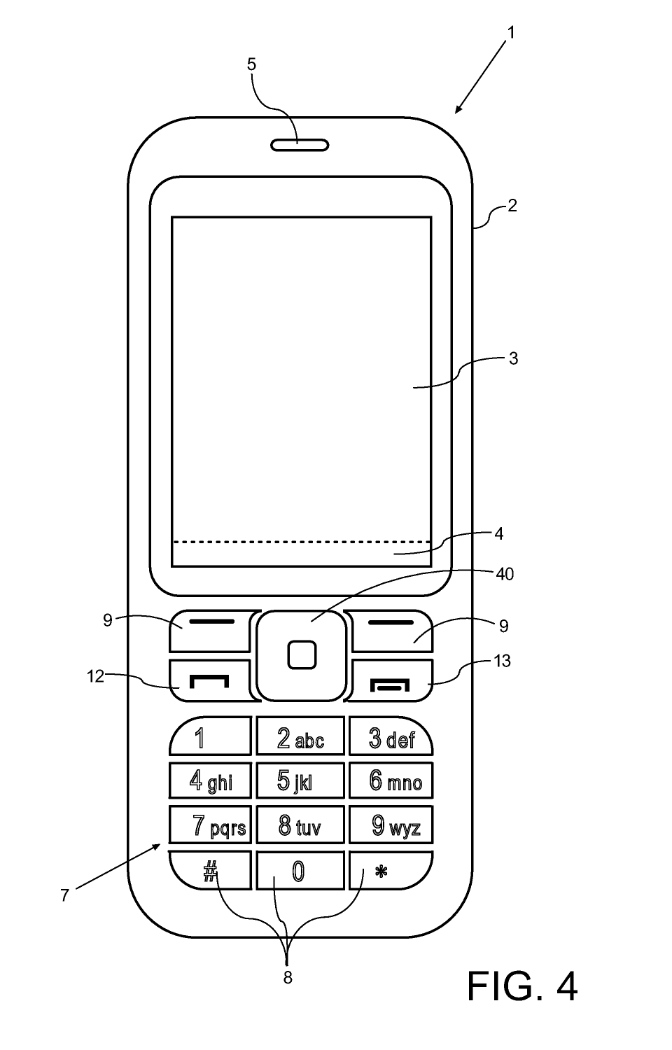

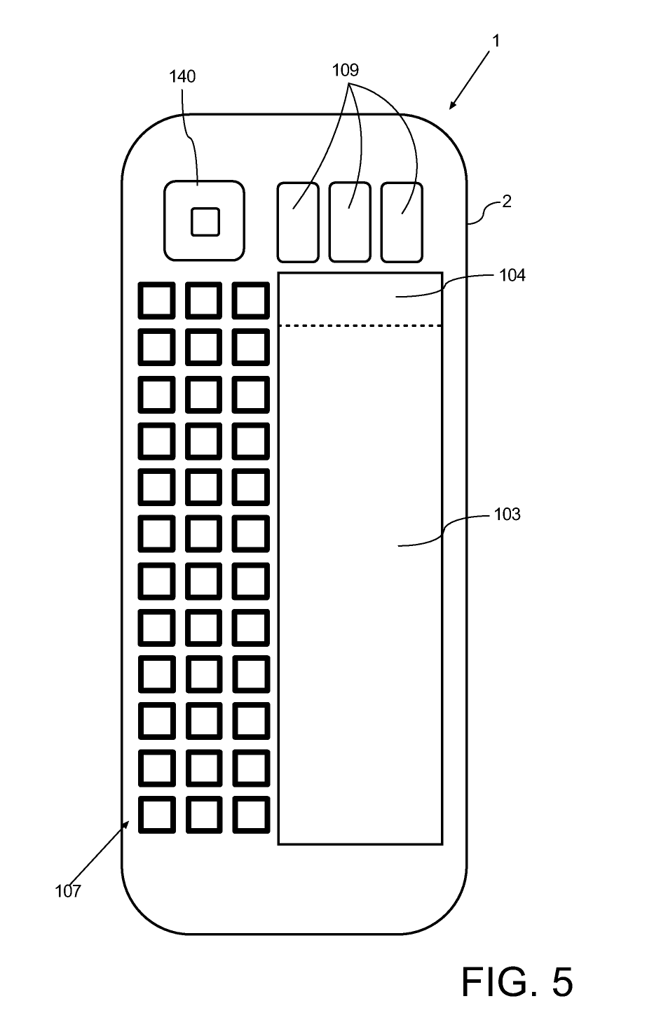

FIG. 4 shows the front of a mobile electronic device according to the second embodiment and FIG. 5 shows the rear of the mobile electronic device according to the second embodiment. The front of the mobile phone 1 according to the second embodiment is very similar to the front of the mobile phone according to the first embodiment. The user interface includes a display screen 3, a speaker 5, a microphone (not shown), a keyboard 7 with a first group of keys including a plurality of alphanumerical keys 8 and a second group of keys including the softkeys 9 and the call handling keys 12 and 13. Instead of the horizontal and vertical scroll devices and the select key this second embodiment is provided with a five-way navigation key 40. The navigation key 40 can be used for cursor movement, scrolling and selecting and is placed centrally on the front surface of the phone between the display screen 3 and the group of alphanumeric keys 8. The operation of user interface on the front of the phone according to the second embodiment is analogous to the operation of the keys on the mobile phone according to the first embodiment.

The rear of the mobile phone 1 according to the second embodiment is very different from the rear of the mobile phone according to the first embodiment in that the rear of the mobile phone 1 according to the second embodiment is provided with a further user interface including a “QWERTY” type keyboard 107, the softkeys 109, a five way navigation key 140 and an oblong display screen 103. The user face on the rear of the phone is particularly useful for entering longer texts such as for example messages or for word processing. The orientation of the user interface on the rear of the mobile phone is such that the mobile phone 1 will typically be in a horizontal position (not shown in the figures) or with the rear of the phone facing upwards is during use. The information on the display screen 103 is oriented so that it can be read when the phone is in the horizontal position. Also the labels in the dedicated display area 104 are oriented to be read with the phone in the horizontal position. The mobile phone 1 according to the second embodiment is provided with an orientation sensor 22 (three- or two axis sensor) coupled to the processor 18.

The software in the flash ROM 16 contains program code instructing the processor 18 to disable the keyboard 107 on the rear of the mobile phone 1 when the mobile phone is in an upright position/orientation. Simultaneously, the processor enables the keypad 1 on the front of the mobile phone 1. In this context the term “upright position/orientation” is not limited to an orientation in which the longitudinal axis of the mobile phone is exactly aligned with the vertical. A substantial deviation from the absolute vertical is allowed before the processor does not consider the orientation of the phone any longer as upright. Therefore, the processor 18 maintains the enablement over a range of orientations.

The software in the flash ROM 16 also contains program code instructing the processor 18 to disable the keyboard 7 on the front of the mobile phone 1 when the mobile phone is in a horizontal position or in a position with the keypad 107 facing upwards. Simultaneously, the processor enables the keypad 107 on the rear of the mobile phone 1. In this context the term “horizontal” and “upwards” is not limited to orientations that match the orientation of the gravitational field exactly. A substantial deviation from the exact alignment with the gravitational field is allowed, and the terms “horizontal” and “upwards” are to be interpreted as ranges of orientations that are associated with the exact horizontal and exact upwards to orientations.

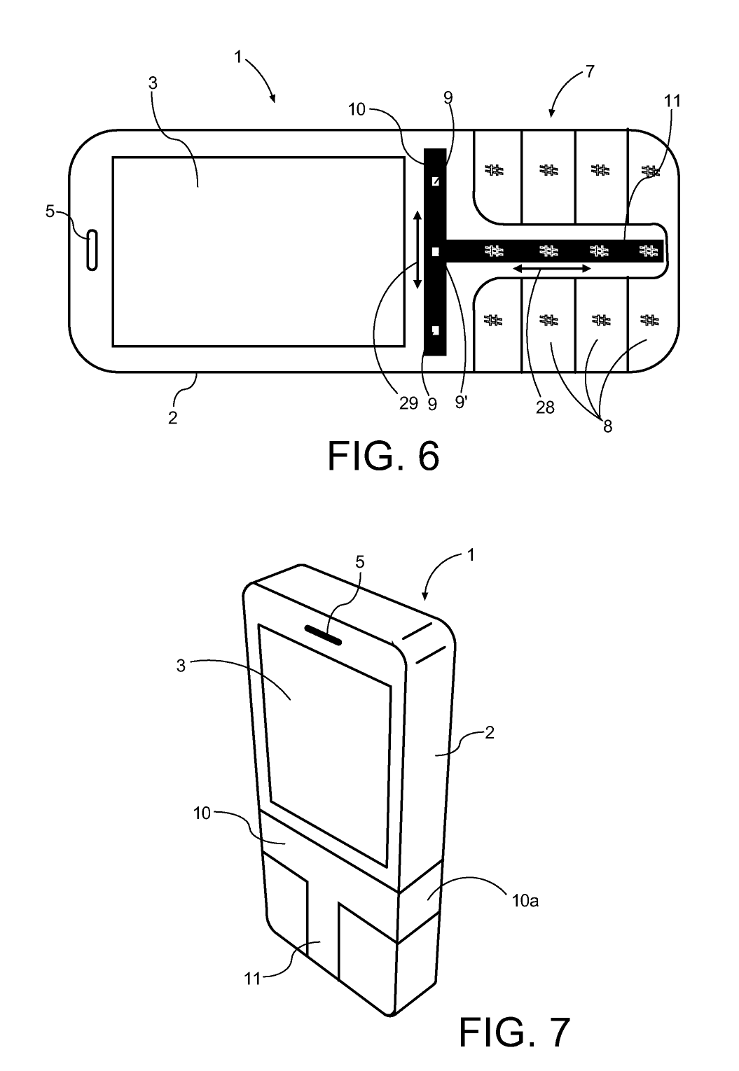

FIG. 6 shows the front of a mobile electronic device according to the third embodiment. The third embodiment is essentially identical to the first embodiment, except that both the horizontal scrollbar 10 and the vertical scrollbar 11 are mounted on the front surface of the mobile electronic device 1. The touch surface of the vertical scroll 11 bar is at its “upper” extremity connected to the touch surface of the vertical scrollbar 10. The connection between the two touch surfaces is in an embodiment substantially in the middle of the longitudinal extension of the horizontal scrollbar 10 and may be substantially flush. The scrollbars according to the illustrated embodiment have a T-shaped arrangement. Other arrangements, such as an L-shaped arrangement are also possible. The touch surfaces of the two scrollbars 10,11 may be manufactured from one piece of material, so that a user sliding a finger over the transition between the two scrollbars will not notice the transition.

When the terminal one is in the orientation depicted in FIG. 6, and a scrollable array of items is shown in the display screen 3, the processor 18 will in an embodiment associate a sliding movement of an object over the vertical scrollbar 11 (indicated by arrow 28) with a scrolling function, and associate a sliding movement of an object over the horizontal scrollbar 10 (as indicated by arrow 29) with a zooming or change in detail level control function.

According to an embodiment, a tilt sensor 22 informs the processor 18 of the present orientation of the mobile electronic device, and the processor 18 will swap the a control functions associated with the horizontal scrollbar 10 and the vertical scrollbar 11 to control a zoom or level of detail control function, so that the user can use the horizontal scrollbar 10 to scroll through an array and use the vertical scrollbar 11 when the mobile electronic device 1 is in an upright position. However, the interchange between the control functions may depend on the type of control functions and the type of application that they are associated with, and on the type of orientation change. In some cases it will therefore not be necessary or not even desirable to swap between the two functions.

In the third embodiment of the vertical scrollbar 11 is fully integrated into the keypad 7, with the middle column of the alphanumerical keys 8 being mapped thereunder. Thus, when a user presses on the positions of the vertical scrollbar 11 that are marked by the “#” signs, the processor 18 will consider this input as the pressing of the alphanumerical key corresponding to such a position. The resulting input will depend on the active application. The left- and right column of alphanumerical keypad are formed by conventional alphanumerical keys 81. The vertical scrollbar 11 is therefore an integral part of the alphanumerical keypad, which means that precious operating face area is used more effectively.

The softkeys 9 and eventually also a select key 9′ are mapped under the horizontal scrollbar 10. Thus, when a user presses the horizontal scrollbar 10 in the areas marked with a white square (without any substantial sliding movement over the scrollbar) the processor 18 will interpret the input as the pressing of the key corresponding to such a location, for example the left or right softkey 9. The horizontal keypad 11 is therefore an integral part of the keypad 7, which means that precious operating face area is used more effectively.

According to an embodiment the processor 18 is configured to interpret a substantially non-sliding touch on the scrollbar in one of the areas of the scrollbars 10,11 that are mapped as a key of the keypad 7 as a keystroke. According to another embodiment the processor 18 is configured treat a non-sliding touch on the scrollbars 10,11 in one of the areas of the scrollbars 10,11 that are mapped as a key of the keypad 7 as a keystroke when the touch is brief or momentary.

Typically, at least a substantial portion of the keys of the keypad 7 are mapped as columns and rows. According to an embodiment the horizontal scrollbar 10 forms at least a part of one of the rows and the vertical scrollbar 11 forms at least part of one of the columns.

FIG. 7 shows a variation of the mobile electronic device according to the third embodiment. The variation of FIG. 7 is essentially identical to the third embodiment except that at least one of the scrollbars is wrapped around a side of the housing 2 of the mobile electronic device 1. Thus, the user can continue with sliding movement around the edges of the housing 2. Preferably, and the horizontal scrollbar 10 is disposed over the full width of the front surface of the housing 2 and wrapped around both sides with additional touch areas 10a.

According to an embodiment (not shown), the scroll surface of the horizontal 10 scrollbar continues on the rear side of the mobile electronic device 1 to form a continuous ring of touch sensitive surface circumventing the housing 2. Thus, the user has a possibility to perform a continuous scrolling movement by swirling his/her finger over the touch sensitive surface around the mobile electronic device 1.

Various types of orientation sensors 22 can be used with the present invention, such as inclinometers, accelerometers, electrolytic tilt sensors, capacitive tilt sensors, gas bubble in liquid tilt sensors, mercury switches, and pendulums. The tilt/orientation sensor has to measure about at least two axis, preferably three axis.

The various aspects of the invention described above can be used alone or in various combinations. The invention is preferably implemented by a combination of hardware and software, but can also be implemented in hardware or software. The invention can also be embodied as computer readable code on a computer readable medium. Furthermore, although a scrolling feature is described, it should be noted that a scrolling feature is not the limitation and that the scrollbars may be used to manipulate other features. For example, the scrollbars may be used to adjust the volume control in an audio application. In addition, the scrollbars may also be used in video game applications.

The invention is not limited to the enablement and disablement of two scroll devices or two separate keyboards keypad, it is understood that the same principle can be used for any other type of competing input devices such as scroll wheels, joysticks, touchpads, rotators, slide switches, etc.

For example, although the invention has been described in terms of a mobile phone, it should be appreciated that the invention may also be applied to other types of electronic devices, such as cameras, video recorders, music players, palmtop computers and the like.

The term “comprising” as used in the claims does not exclude other elements or steps. The term “a” or ^{an} as used in the claims does not exclude a plurality. The single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention.

1. A mobile electronic device, comprising:
a processor controlling the operation of the mobile electronic device,
an orientation sensor to detect a current orientation of the mobile electronic device,
a first input device configured to accept user input when the mobile electronic device is in a first orientation, and
a second input device configured to accept user input when the mobile electronic device is in a second orientation,
said orientation sensor, said first input device and said second input device being coupled to the processor and said processor being configured to enable and disable said first input device and said second input device in accordance with the orientation of the mobile electronic devices as detected by the orientation sensor.

2. A mobile electronic device according to claim 1, wherein said processor is configured to disable said second input device when the orientation sensor detects that the terminal is in a first orientation range.

3. A mobile electronic device according to claim 2, wherein said processor is configured to enable said first input device when the orientation sensor detects that the terminal is in a first orientation range.

4-5. (canceled)

6. A mobile electronic device according to claim 1, wherein herein said first input device and said second input device are substantially identical devices.

7. (canceled)

8. A mobile electronic device according to claim 1, wherein at least one of said first input device and said second input device is a keypad.

9. A mobile electronic device according to claim 1, wherein at least one of said first input device and said second input device is a touchpad.

10. A mobile electronic device according to claim 1, wherein at least one of said first input device and said second input device is a scroll key or touch sensitive scroll surface.

11-19. (canceled)

20. A mobile electronic device that can be used in at least two different orientations, said mobile electronic device comprising:
an elongated housing,
a processor controlling the operation of the mobile electronic device,
a first scrollbar supported by said elongated housing with said first scrollbar extending in a direction substantially traverse to the longitudinal axis of said elongated housing,
a second scrollbar supported by said elongated housing with said second scrollbar substantially extending in the direction of the longitudinal axis of said elongated housing,
said first scrollbar and said second scrollbar being coupled to the processor and said processor being configured to associate a first control function of an application associated with said mobile electronic device to said first scrollbar and to associate a second control function of said application associated with said mobile electronic device to said second scrollbar.

21. An electronic device according to claim 20, further comprising a display screen coupled to said processor, wherein said application is application displaying an array of items and said first control function is a scroll function and said second control function is a zooming or detail level control function.

22. An electronic device according to claim 21, wherein said items are menu items and said zooming or detail level control function controls the displayed level of detail associated with the menu items.

23. An electronic device according to claim 21, wherein said items are images or videos displayed by a media player and said zooming or detail level control function controls the size of the displayed images or videos on the display screen.

24. An electronic device according to claim 21, wherein said media items are songs displayed by a media player, and said zooming or detail level control function controls the displayed level of detail associated with the songs.

25. An electronic device according to claim 21, wherein said items are phone book entries displayed by a phonebook application, and said zooming or detail level control function controls the displayed level of detail associated with the phonebook entries.

26. An electronic device according to claim 20, further comprising an orientation sensor and wherein said processor is configured to interchange the control functions associated with said first and second scrollbars in response to a signal from said orientation sensor.

27-29. (canceled)

30. A mobile electronic device comprising:
a housing,
a scrollbar supported by the housing, and
a keypad supported by the housing, wherein
said scrollbar and said keypad overlap one another, with one or more of the keys on said keypad being mapped under the scrollbar.

31. A mobile electronic device according to claim 30, wherein said scrollbar is an integral part of said keypad.

32. A mobile electronic device according to claim 30, further comprising a processor coupled to said keypad and to said scrollbar, wherein said processor is configured to treat a substantially non-sliding touch on said scrollbar as a keystroke.

33. A mobile electronic device according to claim 32, wherein said processor is configured to treat a substantially non-sliding touch on said scrollbar in one of the areas of said scrollbar that are mapped as a key of said keypad as a keystroke.

34. A mobile electronic device according to claim 33, wherein said processor is configured treat a non-sliding touch on said scrollbar in one of the areas of said scrollbar that are mapped as a key of said keypad as a keystroke when said touch is brief or momentary.

35. An electronic device according to claim 30, wherein the keys of said keypad are mapped as columns and rows, with said scrollbar forming at least a part of one of said columns or rows.

36-44. (canceled)
